(19) United States
(12) Patent Application Publication
(10) Pub. No.: US 2016/0142241 A1
(43) Pub. Date: May 19, 2016

(54) Cell Search Procedure Frame Format

(71) Applicant: Telefonaktiebolaget L M Ericsson (publ), Stockholm (SE)

(72) Inventors: Henrik SAHLIN, Molnlycke (SE); Mona HASHEMI, Goteborg (SE); Jingya LI, Gothenburg (SE); Emil RINGH, Stockholm (SE)

(21) Appl. No.: 14/541,922

(22) Filed: Nov. 14, 2014

(51) Int. Cl. H04L 27/26; H04W 72/04; H04W 56/00

(52) U.S. Cl. CPC H04L 27/2656; H04W 56/0015; H04W 72/042

(57) ABSTRACT

According to some embodiments, a method of synchronizing a wireless device with a network node comprises receiving a radio subframe transmitted from the network node. The radio subframe comprises a first Primary Synchronization Signal (PSS) associated with a first Orthogonal Frequency Division Multiplexing (OFDM) symbol and paired with a first Secondary Synchronization Signal (SSS) associated with a second OFDM symbol. The radio subframe also comprises a second PSS associated with a third OFDM symbol and paired with a second SSS associated with a fourth OFDM symbol. The method further comprises detecting at least one of the first PSS and the second PSS within the radio subframe and detecting at least one of the first SSS and the second SSS within the radio subframe. The method determines system information associated with the network node based on the detected at least one PSS and the detected at least one SSS.

### TECHNICAL FIELD

Particular embodiments relate generally to synchronization signals in wireless communications, and more particularly to frame formats for cell search procedure synchronization signals.

### BACKGROUND

When a wireless device powers on or moves between cells in a wireless network, the wireless device receives and synchronizes to downlink signals in a cell search procedure. The cell search procedure identifies a preferable cell and performs time and frequency synchronization to the network in downlink (e.g., from a base station to a user equipment).

A user equipment (UE) may use primary and secondary synchronization signals (PSS and SSS), such as those described in Section 6.11 of Third Generation Partnership Project (3GPP) TS 36.211, version 11.2.0, for performing a cell search procedure, such as the cell search procedure described in Section 4.1 of 3GPP TS 36.213, version 12.1.0. 3GPP specifies that for frequency division duplex (FDD) PSS is transmitted in the last orthogonal frequency division multiplexing (OFDM) symbol of slots 0 and 10 within a radio frame and that SSS is transmitted in the OFDM symbol preceding PSS, such as illustrated in FIG. 2. 3GPP specifies that for time division duplex (TDD) PSS is transmitted in the third OFDM symbol of slots 3 and 13 within a frame and that SSS is transmitted in the last OFDM symbol of slots 2 and 12 (i.e., three symbols ahead of the PSS).

FIG. 3 illustrates an example of an initial cell search procedure. A UE typically may have a frequency error of 2 to 20 ppm (part per million) at power on. This corresponds to 40 to 400 kHz frequency error at a carrier frequency of 2 GHz. The UE then tries to detect a PSS. From the detected PSS, the UE may derive the cell id within a cell-identity group, which consists of three different cell identities corresponding to three different PSS. To perform the detection, the UE searches for all of the three possible cell identities. The UE may also determine an OFDM symbol synchronization and a coarse frequency offset estimation with an accuracy of about 1 kHz. The UE estimates the latter by evaluating several hypotheses of the frequency error.

The UE then detects the SSS. From the detected SSS, the UE acquires the physical cell id and achieves radio frame synchronization. The UE also detects whether the cyclic prefix length is normal or extended. A UE that is not preconfigured for a particular duplex mode (e.g., TDD or FDD) may detect the duplex mode by the frame position of the detected SSS in relation to the detected PSS. The UE may estimate fine frequency offset by correlating PSS and SSS. Alternatively, the UE may use cell-specific reference signals (CRS) to estimate fine frequency offset.

After synchronizing with the PSS and the SSS, the UE may receive and decode cell system information, which contains cell configuration parameters such as the Physical Broadcast Channel (PBCH). The number of OFDM symbols used for PDCCH (Physical Downlink Control Channel) is signaled by PCFICH (Physical Control Format Indicator Channel) according to Section 6.7 of 3GPP TS 36.211, version 11.2.0. The PCFICH is decoded before the UE receives PDCCH. The number of OFDM symbols signaled by PCFICH may be 1, 2 or 3 for large bandwidth allocations (e.g., more than 10 resource blocks) and 2, 3 or 4 OFDM symbols for small bandwidths (e.g., less than or equal to 10 resource blocks). The first OFDM symbols of a sub-frame are used for PDCCH.

Section 6.10.1 of 3GPP TS 36.211, version 11.2.0, illustrates CRS mappings for one, two, and four antenna ports. As illustrated in the 3GPP specification, CRS are not mapped on the same OFDM symbols as used for PSS and SSS.

### SUMMARY

According to some embodiments, a method of synchronizing a wireless device with a network node comprises receiving a radio subframe transmitted from the network node. The radio subframe comprises a first Primary Synchronization Signal (PSS) associated with a first Orthogonal Frequency Division Multiplexing (OFDM) symbol and paired with a first Secondary Synchronization Signal (SSS) associated with a second OFDM symbol. The radio subframe also comprises a second PSS associated with a third OFDM symbol and paired with a second SSS associated with a fourth OFDM symbol. The method further comprises detecting at least one of the first PSS and the second PSS within the radio subframe and detecting at least one of the first SSS and the second SSS within the radio subframe. The method determines system information associated with the network node based on the detected at least one PSS and the detected at least one SSS.

In particular embodiments, the first, second, third, and fourth OFDM symbols do not include OFDM symbols reserved for Physical Downlink Control Channel (PDCCH). In particular embodiments, the first, second, third, and fourth OFDM symbols do not include the last and second-to-last OFDM symbol of slot zero and the last and second-to-last OFDM symbol of slot ten within a frame configured for frequency division duplex and the third-position OFDM symbol of slot three and slot thirteen and the last OFDM symbol of slot two and slot twelve within a frame configured for time division duplex. In particular embodiments, the first, second, third, and fourth OFDM symbols do not include OFDM symbols that include Cell Reference Signals (CRS).

In particular embodiments, the method comprises detecting both the first PSS and the second PSS within the radio subframe and accumulating the first PSS and the second PSS. The method further comprises determining system information associated with the network node based on the accumulated first PSS and second PSS.

In particular embodiments, the method comprises accumulating the detected at least one PSS and a PSS detected in a previously received subframe and determining system information associated with the network node based on the detected at least one PSS and the PSS detected in a previously received subframe.

Particular embodiments may exhibit some of the following technical advantages. Particular embodiments may include a PSS and SSS cell search frame format that is backward compatible such that legacy UEs will not detect these cell search signals or need to be aware of their existence. Particular embodiments use synchronization sequences other than those specified in LTE release 12. In particular embodiments, cell search signals are placed in resource blocks that are not scheduled to legacy UEs. In particular embodiments, PSS and SSS frame formats may use a large fraction of the reserved resource blocks which results in low overhead. Particular embodiments may allocate PSS/SSS pairs in subsequent OFDM symbols such that a high resolution frequency offset estimate can be calculated with low computational complexity.

In particular embodiments, a PSS/SSS pair is not transmitted such that PSS is transmitted in one slot and SSS in the next, or vice versa. The first symbol of each slot has a longer cyclic prefix than the other OFDM symbols of the slot. In embodiments that transmit a PSS/SSS pair in the same slot, the timing between PSS and SSS within each pair is constant, such that the phase rotation between PSS and SSS may be used for a fine granularity frequency offset estimator. In particular embodiments, a UE may use coherent accumulation to improve the received SINR. In particular embodiments, a base station may use beamforming or repetition of PSS and SSS to increase successful cell detection rate and reduce cell detection latency. Other technical advantages will be readily apparent to one skilled in the art from the following figures, description and claims.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example of a network, according to a particular embodiment;

FIG. 2 illustrates an example radio frame and locations of OFDM symbols used for PSS and SSS, according to a 3GPP specification;

FIG. 3 is a flowchart of an example method for performing cell search synchronization, according to a particular embodiment;

FIGS. 4-16 illustrate example locations of primary and secondary search signals within a subframe, according to particular embodiments;

FIG. 17 is a flowchart of an example method for transmitting PSS and SSS, according to a particular embodiment;

FIG. 18 is a flowchart of an example method for detecting PSS and SSS, according to a particular embodiment;

FIG. 19 is a block diagram illustrating an example embodiment of a wireless device; and

FIG. 20 is a block diagram illustrating an example embodiment of a radio network node.

### DETAILED DESCRIPTION

In particular networks, a UE might receive cell search signals at a low signal to interference plus noise ratio (SINR), which results in degraded or impossible cell attachment. 3GPP specifies that the same synchronization signals are transmitted each 5 ms. A UE might attempt to accumulate several occasions of these signals; however, fading radio channel and frequency errors negatively impact this possibility. A fading radio channel exhibits time variations both in amplitude and phase. The speed of these variations depends on both the speed of the UE and how the radio propagation environment is changing. In both cases, these variations may result in received signals that cannot be accumulated coherently in order to increase SINR. The phase variations may lead to a destructive superposition at this accumulation.

Furthermore, frequency error between a base station transmitter and a UE may also result in a channel with large phase variations over time. A UE typically has an oscillator that determines the frequency reference for its receiver with an accuracy of around 20 ppm. With a carrier frequency of 2 GHz, this results in a frequency error of 400 kHz. In order to estimate this frequency error, several PSS detectors could possibly be used in parallel, each with a different hypothesis of the frequency error. With an interval of 5 ms between the PSS transmission, the resolution of these frequency hypothesis signals would need to be 1/(5·[(10)]̂(−3))/100=2 Hz with a required accuracy of one percent. Thus, estimating frequency errors up to 400 kHz is a computationally complex solution.

An alternative may be for a UE to use a non-coherent accumulation in its receiver. Non-coherent accumulation, however, does not increase the SINR. It only improves the statistics of the receiver (i.e., the sensitivity to variations in individual noise samples).

A particular technique to improve coverage of cell search signals uses several antenna elements and beamforming to improve the SINR. A directional cell search procedure is proposed by C. Nicolas Barati et al. in “Directional Cell Search for Millimeter Wave Cellular Systems”, Cornell University Library. In this procedure a base station periodically transmits synchronization signals in random directions to scan the angular space. The need for synchronization and broadcast signals that can be used in the initial cell search for scanning over a range of angles is discussed by Sundeep Rangan et al. in “Millimeter-Wave Cellular Wireless Networks: Potentials and Challenges”, Proceedings of the IEEE, Volume: 102, Issue 3, 2014, pages 366-385.

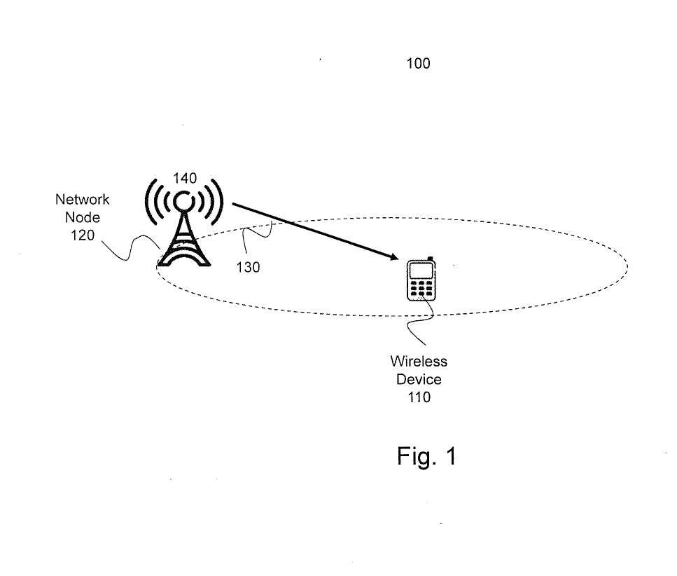

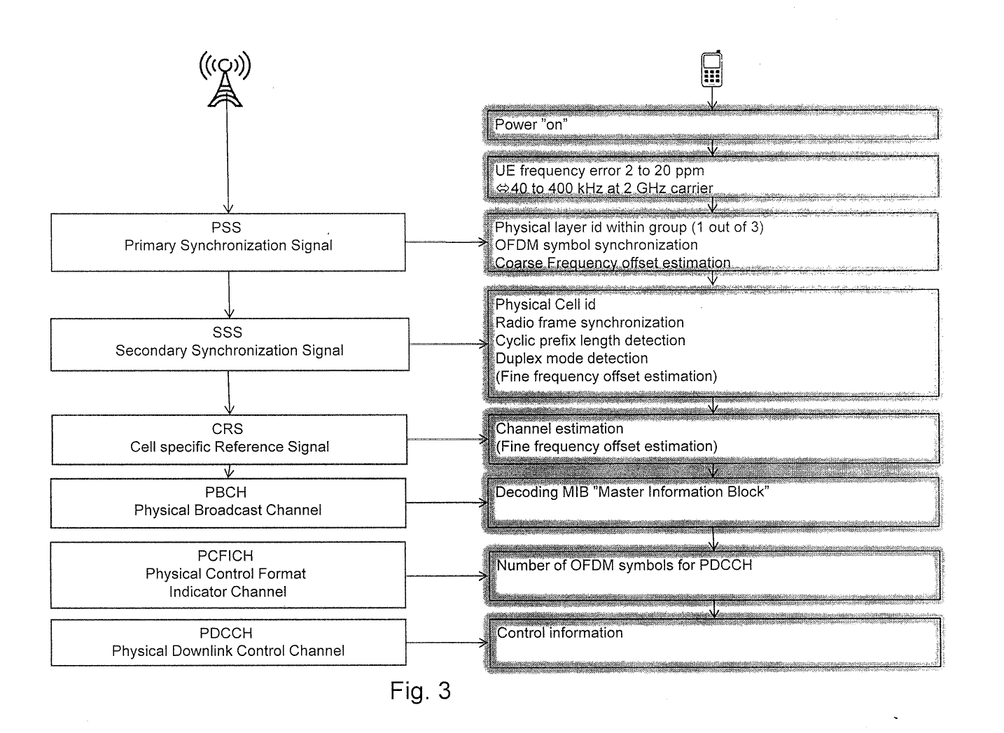

An object of the present disclosure is to obviate at least these disadvantages and provide an improved method to transmit synchronization signals with a density and directionality that enables successful cell search in low SINR environments. Particular embodiments are described with reference to FIGS. 1-20 of the drawings, like numerals being used for like and corresponding parts of the various drawings. LTE is used throughout this disclosure as an example cellular system, but the ideas presented herein apply to other wireless communication systems as well.

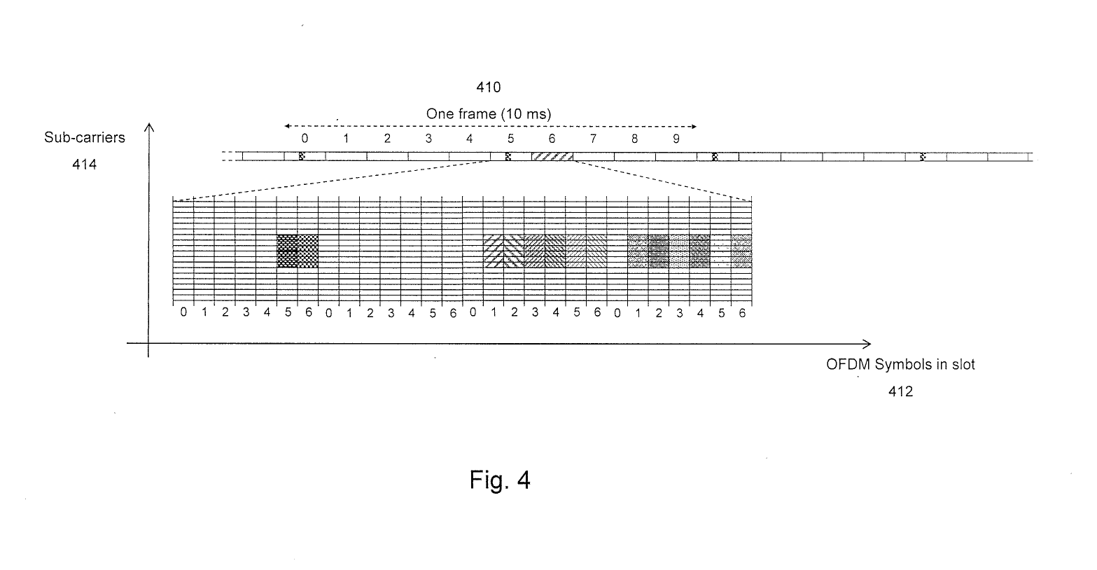

FIG. 1 is a block diagram illustrating an example of a network, according to a particular embodiment. Network 100 includes radio network node 120 (such as a base station or eNodeB) and wireless devices 110 (such as mobile phones, smart phones, laptop computers, tablet computers, or any other devices that can provide wireless communication). In general, wireless devices 110 that are within coverage of radio network node 120 communicate with radio network node 120 by transmitting and receiving wireless signals 130. For example, wireless devices 110 and radio network node 120 may communicate wireless signals 130 containing voice traffic, data traffic, and/or control signals. Wireless signals 130 may include both downlink transmissions (from radio network node 120 to wireless devices 110) and uplink transmissions (from wireless devices 110 to radio network node 120). Wireless signals 130 may include synchronization signals, such PSS and SSS. Wireless device 110 may detect the synchronization signals to determine system information for network 100. Wireless signals 130 comprise radio frames. Particular example formats for these radio frames are illustrated in FIGS. 4-16 described below.

Radio network node 120 transmits and receives wireless signals 130 using antenna 140. In particular embodiments, radio network node 120 may comprise multiple antennas 140. For example, radio network node 120 may comprise a multi-input multi-output (MIMO) system with two, four, or eight antennas 140.

In network 100, each radio network node 120 may use any suitable radio access technology, such as long term evolution (LTE), LTE-Advanced, UMTS, HSPA, GSM, cdma2000, WiMax, WiFi, and/or other suitable radio access technology. Network 100 may include any suitable combination of one or more radio access technologies. For purposes of example, various embodiments may be described within the context of certain radio access technologies. However, the scope of the disclosure is not limited to the examples and other embodiments could use different radio access technologies.

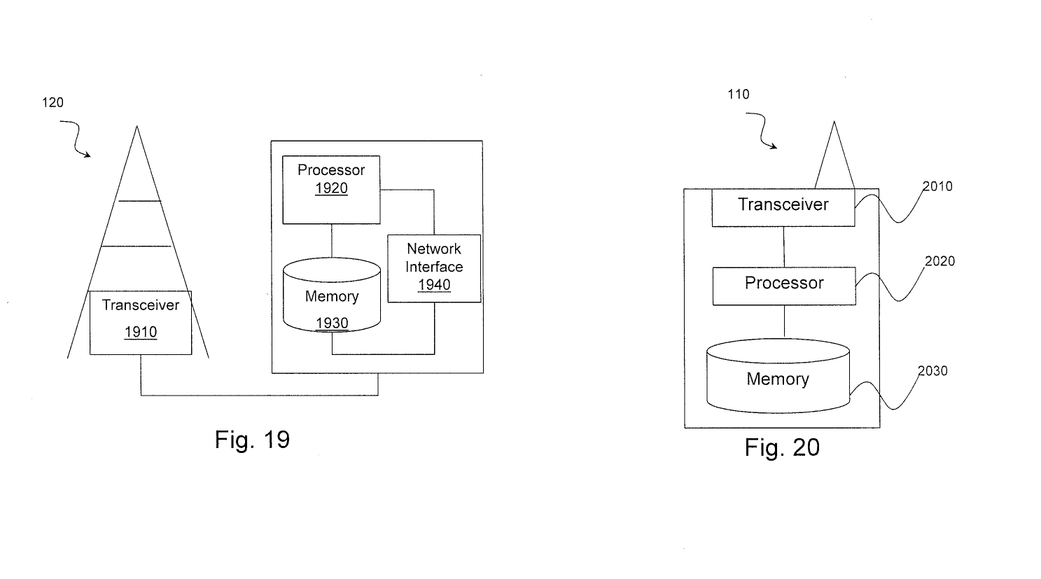

As described above, embodiments of a network may include one or more wireless devices and one or more different types of radio network nodes capable of communicating with the wireless devices. The network may also include any additional elements suitable to support communication between wireless devices or between a wireless device and another communication device (such as a landline telephone). A wireless device may include any suitable combination of hardware and/or software. For example, in particular embodiments, a wireless device, such as wireless device 110, may include the components described with respect to FIG. 19 below. Similarly, a radio network node may include any suitable combination of hardware and/or software. For example, in particular embodiments, a radio network node, such as radio network node 120, may include the components described with respect to FIG. 20 below.

This disclosure describes several frame formats for transmitting and receiving synchronization signals using LTE as an example. Particular embodiments may be applicable to FDD, TDD, or both. With respect to FDD, particular embodiments may apply to all subframes except subframe 0. With respect to TDD, particular embodiments may apply to all subframes except subframes 0 and 1. Subframe 5 may receive special treatment for both TDD and FDD, as described in more detail in the embodiments below. FIGS. 4-16 illustrate example locations of primary and secondary search signals within a subframe, according to particular embodiments.

FIG. 4 is an example cell search frame format for FDD. FIG. 4 illustrates radio frame 410 comprising ten subframes numbered 0-9. Each subframe comprises two slots. Slots of a subframe may be referred to in relation to the subframe (e.g., the first and second slots of subframe 5), or slots may be referred to in relation to the radio frame (e.g., slot 0 is the first slot of subframe 0, slot 1 is the second slot of subframe 0, slot 10 is the first slot of subframe 5, and so on). In FIG. 4, the slots of subframes 5 and 6 are illustrated in an expanded view. Each slot comprises a plurality of OFDM symbols 412, illustrated on the horizontal axis, and a plurality of sub-carriers 414, illustrated on the vertical axis. A time-frequency resource comprising one OFDM symbol and one sub-carrier may be referred to as a resource element.

In this example, SSS and PSS are inserted in subframe 6. A first PSS/SSS pair is transmitted in OFDM symbols 1 and 2 of the first time slot of subframe 6, a second pair is transmitted in OFDM symbols 3 and 4, and a third pair is transmitted in OFDM symbols 5 and 6. In the second slot, the first PSS/SSS pair is transmitted in OFDM symbols 1 and 2. In this example, six PSS/SSS pairs are included within subframe 6. In particular embodiments, the PSS and SSS of a pair are located in the same slot (i.e., a pair does not straddle a slot boundary). This is because a longer cyclic prefix is used for OFDM symbol 0 and the timing between the PSS and the SSS of pair that straddles the slot boundary would differ from other pairs that do not straddle the slot boundary.

FIG. 4 also illustrates legacy SSS and PSS in OFDM symbols 5 and 6 of subframes 0 and 5. Although this example illustrates PSS/SSS pairs in subframe 6, in particular embodiments, pairs of PSS and SSS may be inserted in any subframe as long as the pairs do not conflict with legacy PSS and SSS. In particular embodiments, the subframe number containing the PSS and SSS is fixed such that a UE can determine the timing of the start of the radio frame after detecting both PSS and SSS. For example, if a UE knows the PSS and SSS are transmitted in subframe 6, and a radio frame comprises 10 subframes, then the UE can determine the next radio frame will start after 4 subframes.

In particular embodiments, the SSS and PSS are placed at sub-carriers centered on the DC carrier. Such a configuration enables a UE to detect them without knowing the total system bandwidth.

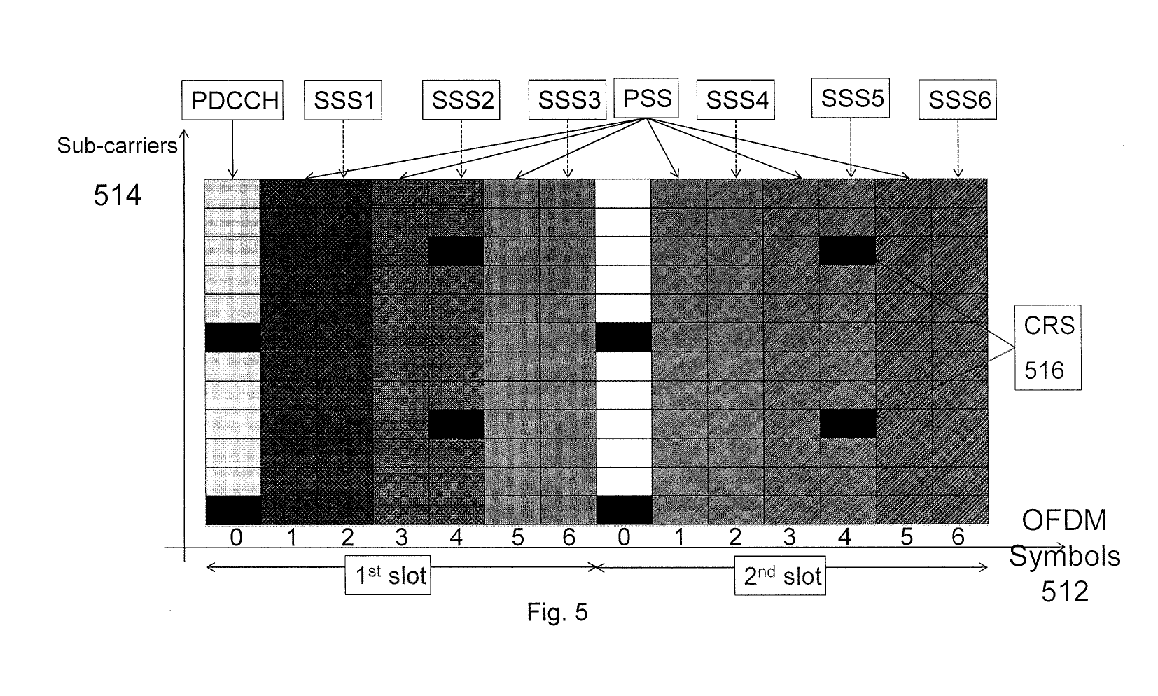

FIG. 5 is another example cell search frame format for FDD. FIG. 5 illustrates two slots of an example subframe. Each slot comprises a plurality of OFDM symbols 512, illustrated on the horizontal axis, and a plurality of sub-carriers 514, illustrated on the vertical axis. CRS 516 are time-frequency resource elements used for transmission of cell-specific reference signals for a configuration with one antenna port.

In this example, the first OFDM symbol of the subframe is not used for PSS or SSS because it contains PDCCH. PSS is transmitted in OFDM symbols 1, 3 and 5 of the first slot and OFDM symbols 1, 3 and 5 of the second slot. In particular embodiments, each of the six PSS comprise the same sequence.

In particular embodiments, the SSS of each pair is transmitted in the next OFDM symbol after the PSS. For example, in the first slot SSS1 is transmitted in OFDM symbol 2 and is paired with the PSS transmitted in OFDM symbol 1. In the second slot, SSS5 is transmitted in OFDM symbol 4 and is paired with the PSS transmitted in OFDM symbol 3. In particular embodiments, each of the six SSS comprise a different sequence. In this example, the sequences transmitted by SSS2 and SSS5 are punctured by CRS 516.

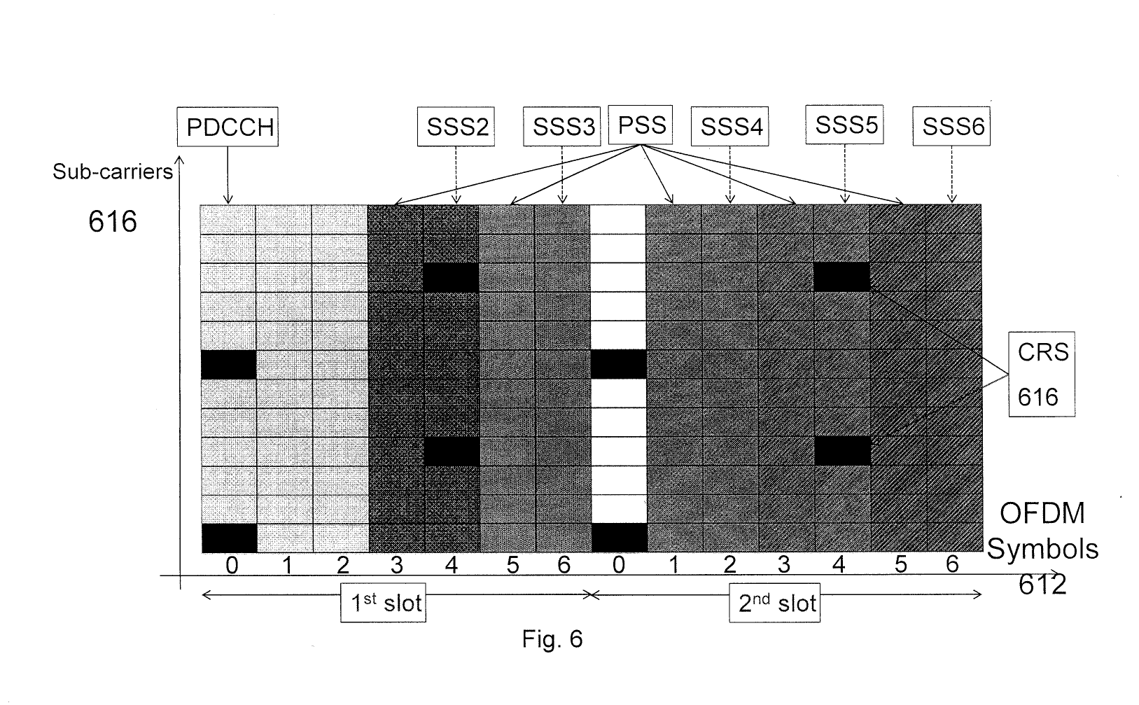

FIG. 6 is another example cell search frame format for FDD. FIG. 6 illustrates two slots of an example subframe similar to FIG. 5, except that in this example the cell is configured (e.g., by PCFICH) to use three OFDM symbols for PDCCH. This example illustrates five PSS/SSS pairs, with the first pair starting in OFDM symbol 3 of the first slot. CRS 616 are time-frequency resource elements used for transmission of cell-specific reference signals for a configuration with one antenna port. As another example (not illustrated), if the cell uses four OFDM symbols for PDCCH, then the first PSS/SSS pair may be transmitted in OFDM symbols 5 and 6.

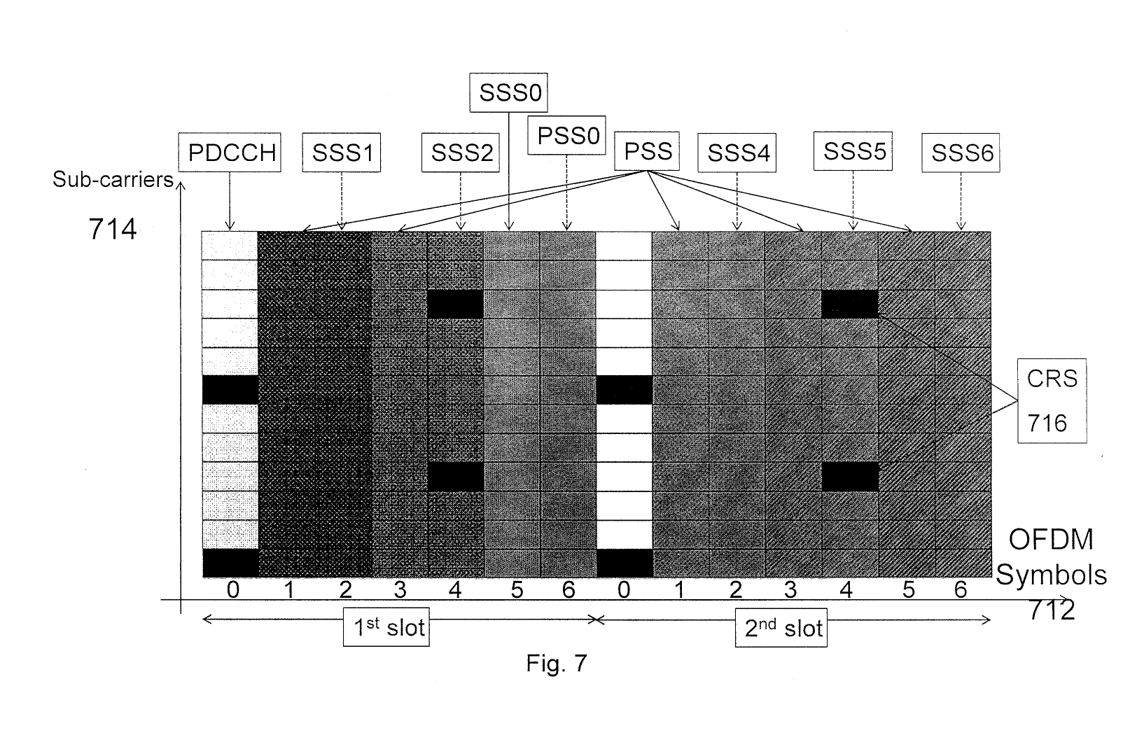

FIG. 7 is another example cell search frame format for FDD. FIG. 7 illustrates two slots of an example subframe similar to FIG. 5, except that the subframe contains legacy PSS and SSS (e.g., subframe 5). As illustrated, SSS0 and PSS0 in OFDM symbols 5 and 6 represent a legacy PSS/SSS pair. The remaining OFDM symbols, except for OFDM symbols 0 in each slot, illustrate five example PSS/SSS pairs. CRS 716 are time-frequency resource elements used for transmission of cell-specific reference signals for a configuration with one antenna port.

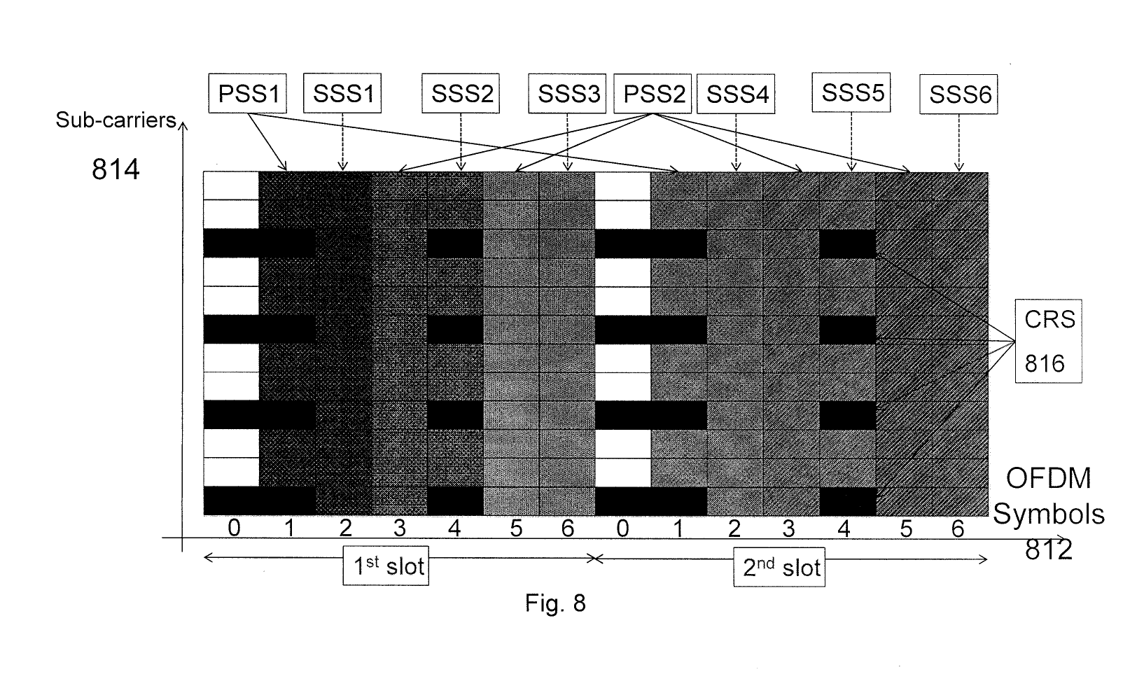

FIG. 8 is another example cell search frame format for FDD. FIG. 8 illustrates two slots of an example subframe similar to FIG. 5, except that in this example CRS 816 represent a four port antenna configuration. In particular embodiments, PSS1 is transmitted in OFDM symbol 1 of both slots and the PSS1 sequence is punctured by CRS 816. PSS2 is transmitted in OFDM symbols 3 and 5 of both slots and the PSS2 sequence is not punctured by CRS 816. In this example, a UE receiving these signals contains logic to detect the two different sequences PSS1 and PSS2.

When a PSS sequence is detected, a UE may continue to detect SSS in the next OFDM symbol after the PSS. The SSS sequences are different on different positions within the subframe, such that the UE may determine the frame timing after SSS detection. Each SSS sequence is associated with a specific OFDM symbol within the subframe and a UE can determine which SSS sequences are punctured by CRS.

In particular embodiments, the first OFDM symbol in a PSS/SSS pair may be used for SSS and the second for PSS. A particular advantage of this ordering is that the order matches the legacy PSS/SSS ordering, which may enable reuse of some existing hardware or software components.

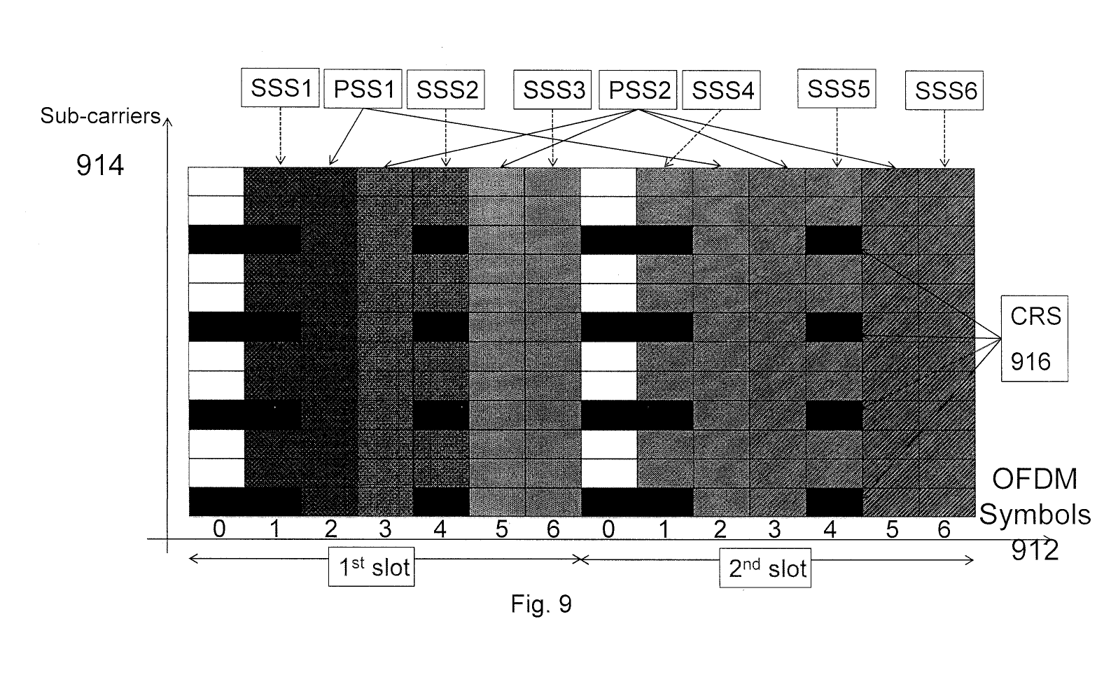

FIG. 9 is another example cell search frame format for FDD. FIG. 9 illustrates two slots of an example subframe similar to FIG. 7. CRS 916 are time-frequency resource elements used for transmission of cell-specific reference signals for a configuration with four antenna ports.

In the example embodiments described above, the first OFDM symbol in a PSS/SSS pair is used for PSS and the second OFDM symbol is used for SSS. A particular advantage of this ordering is that PSS is not punctured. When the PSS is not punctured, the same PSS sequence, and thus also detector, may be used irrespective of the position of the PSS within the subframe.

In the example embodiment illustrated in FIG. 9, a first sequence PSS1 is used in OFDM symbol 2 of both slots, and a second sequence PSS2 is used in OFDM symbols 3 and 5 of both slots. An SSS is positioned in each OFDM symbol preceding the OFDM symbols containing PSS1 and after the OFDM symbols containing PSS2. In operation, a UE will attempt to detect SSS in the OFDM symbol before the PSS if PSS1 is detected or in the symbol after the PSS if PSS2 is detected. In particular embodiments, the SSS sequences are different on different positions within the subframe and a UE can determine the frame timing after SSS detection.

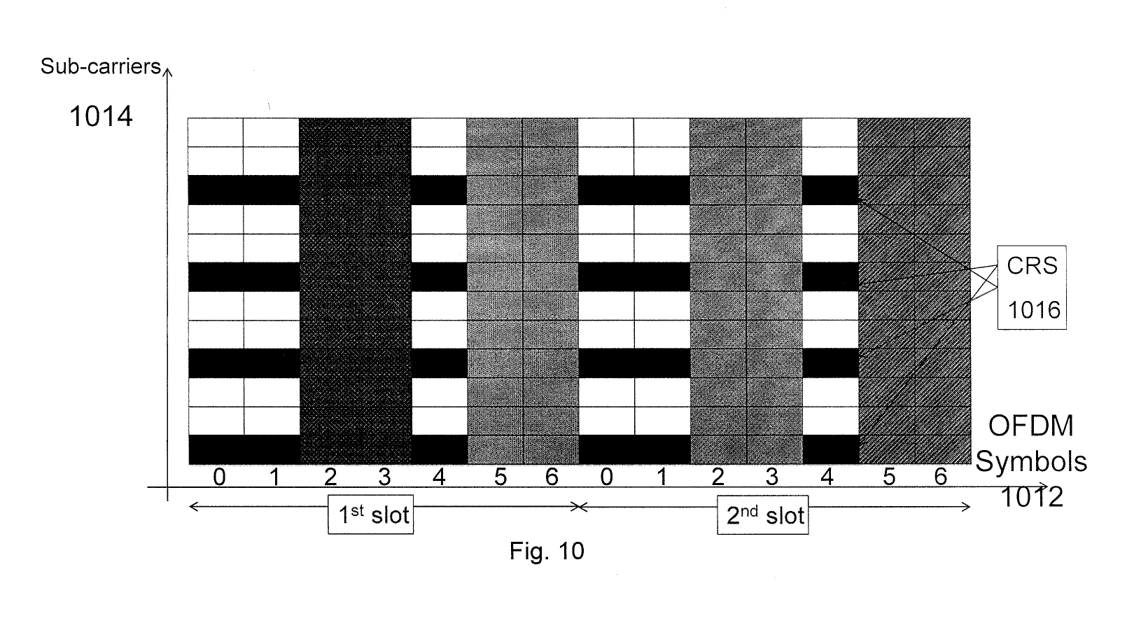

FIG. 10 is another example cell search frame format for FDD. FIG. 10 illustrates two slots of an example subframe similar to FIG. 7. CRS 1016 are time-frequency resource elements used for transmission of cell-specific reference signals for a configuration with four antenna ports. In this example, four PSS/SSS pairs are illustrated. A particular advantage of this configuration is that none of the cell search signals are punctured. Detection of cell search signals may be simplified when the signals are not punctured. In this example, the PSS and SSS may be arranged in either order (i.e., PSS in the first OFDM symbol of the pair and the SSS in the second or vice versa).

Particular embodiments are also applicable to TDD. In the following examples, the corresponding PSS and SSS are separated by two OFDM symbols. This separation may enable a UE to distinguish between duplex modes. As described above, the PSS and SSS may also be arranged with PSS in the first OFDM symbol of the pair and the SSS in the second, or vice versa.

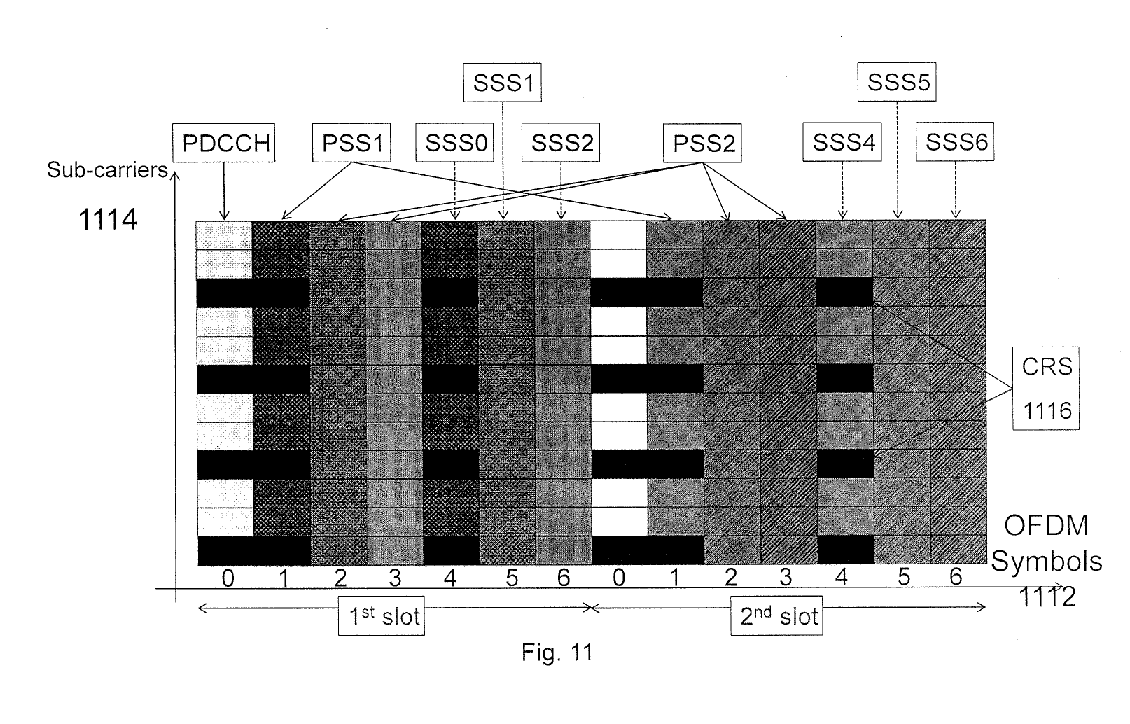

FIG. 11 is an example cell search frame format for TDD. FIG. 11 illustrates two slots of an example subframe similar to the FDD examples described above. The pattern of CRS 1116 represents a four port antenna configuration.

In this example, the corresponding PSS and SSS are separated by two OFDM symbols (e.g., PSS1 in position 1 and SSS0 in position 4, PSS2 in position 2 and SSS1 in position 5, PSS2 in position 3 and SSS2 in position 6, and so on). In this example, PSS1 is transmitted in OFDM symbol 1 of both slots and the PSS1 sequence is punctured by CRS 1116. PSS2 is transmitted in OFDM symbols 2 and 3 of both slots and the PSS2 sequence is not punctured by CRS 1116. In this example, the PSS/SSS pairs do not straddle the slot boundary.

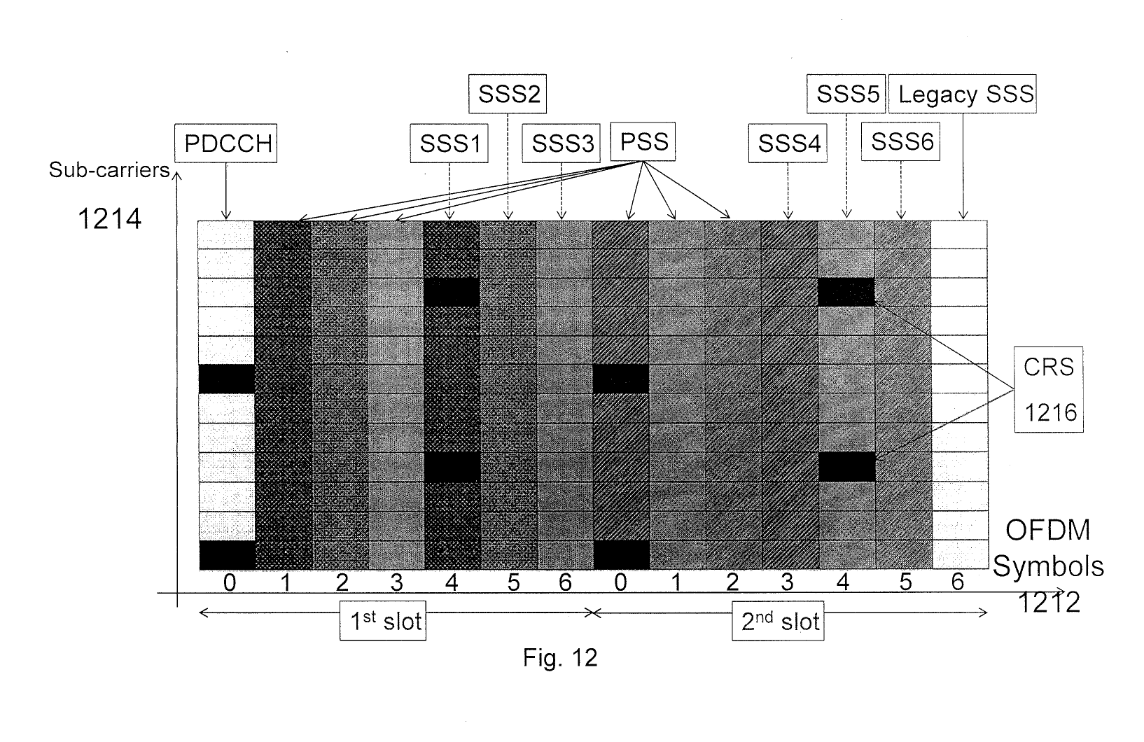

FIG. 12 is another example cell search frame format for TDD. FIG. 12 illustrates two slots of an example subframe similar to FIG. 11, except that the subframe contains legacy SSS (e.g., subframe 5). CRS 1216 are time-frequency resource elements used for transmission of cell-specific reference signals for a configuration with one antenna port. As illustrated, the last OFDM symbol is occupied by a legacy SSS. The remaining OFDM symbols, except for OFDM symbol 0 in the first slot, illustrate six example PSS/SSS pairs. In this example, the corresponding PSS and SSS are separated by two OFDM symbols. In the first slot, PSS is transmitted in OFDM symbols 1, 2 and 3 and the SSS in OFDM symbols 4, 5 and 6. In the second slot, PSS is transmitted in OFDM symbols 0, 1 and 2 and the SSS in OFDM symbols 3, 4 and 5. In this example, the PSS/SSS pairs do not straddle the slot boundary.

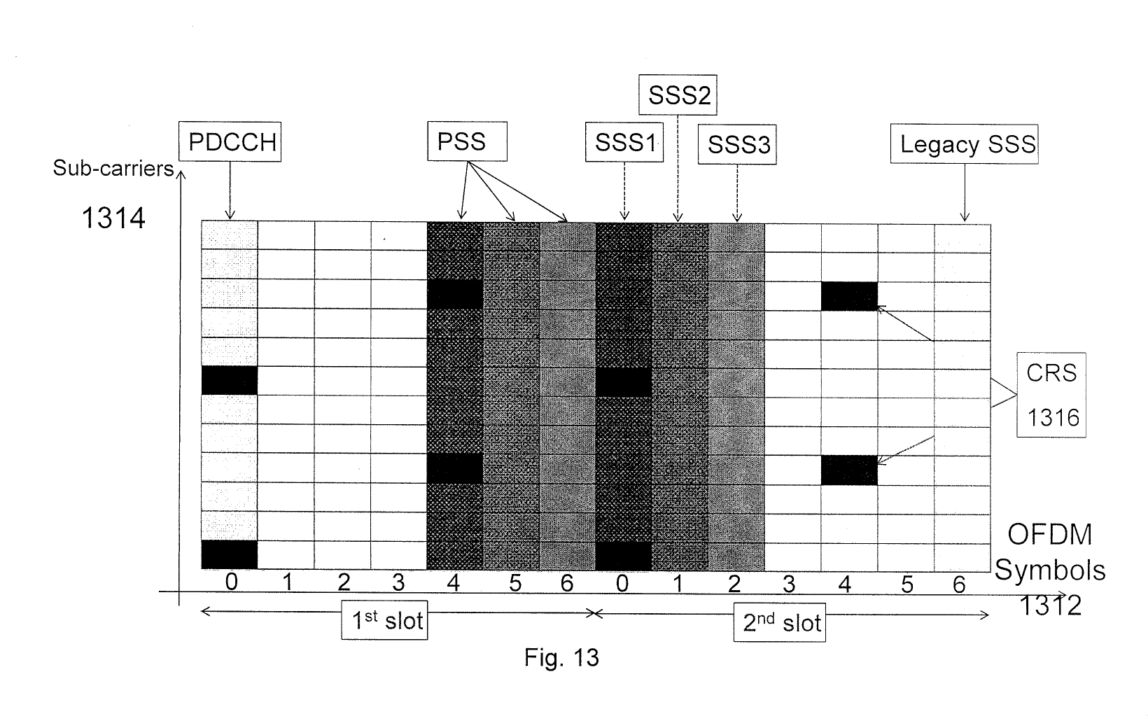

FIG. 13 is another example cell search frame format for TDD. FIG. 13 illustrates two slots of an example subframe similar to FIG. 11. CRS 1316 are time-frequency resource elements used for transmission of cell-specific reference signals for a configuration with one antenna port. This example illustrates three PSS/SSS pairs. Each of these pairs straddles the slot boundary and the long cyclic prefix in the first OFDM symbol of the second slot is included between each pair of PSS and SSS.

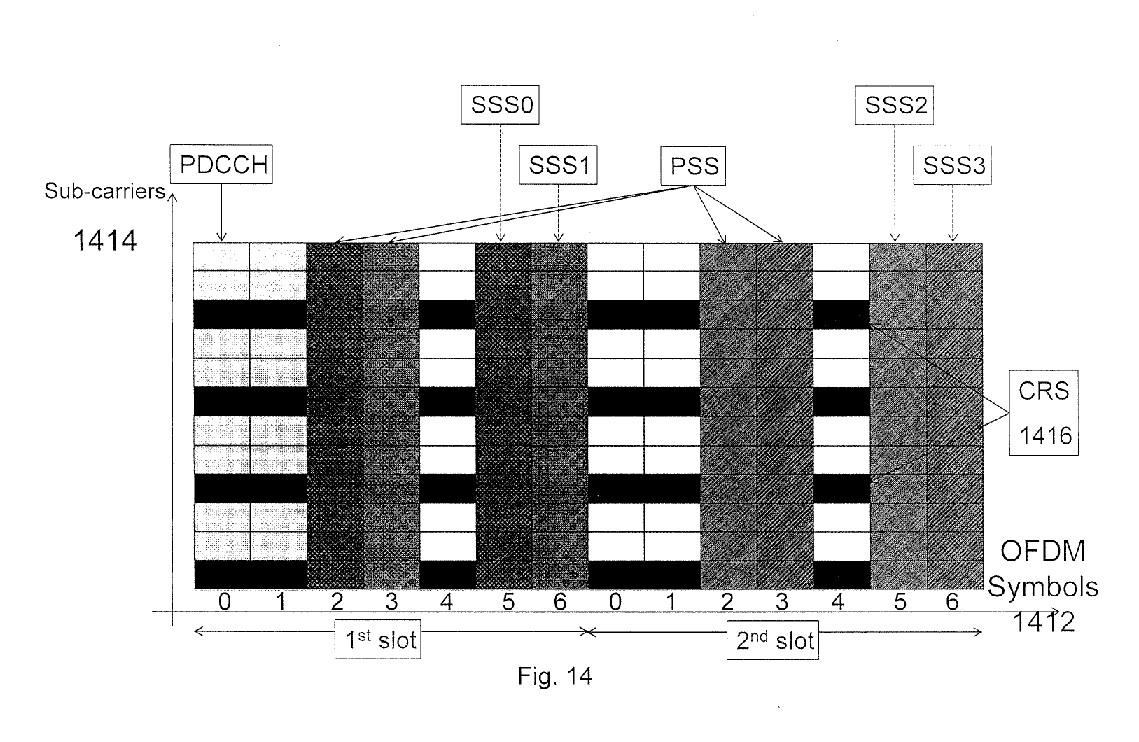

FIG. 14 is another example cell search frame format for TDD. FIG. 14 illustrates two slots of an example subframe similar to FIG. 11. CRS 1416 are time-frequency resource elements used for transmission of cell-specific reference signals for a configuration with four antenna ports. In this example, four PSS/SSS pairs are illustrated. A particular advantage of this configuration is that none of the cell search signals are punctured. In particular embodiments, the PSS and SSS may be arranged in either order (i.e., PSS in the first OFDM symbol of the pair and the SSS in the second as illustrated, or vice versa).

Although the examples above are described with respect to a subframe with a normal length cyclic prefix, particular embodiments may also apply to subframes with an extended length cyclic prefix.

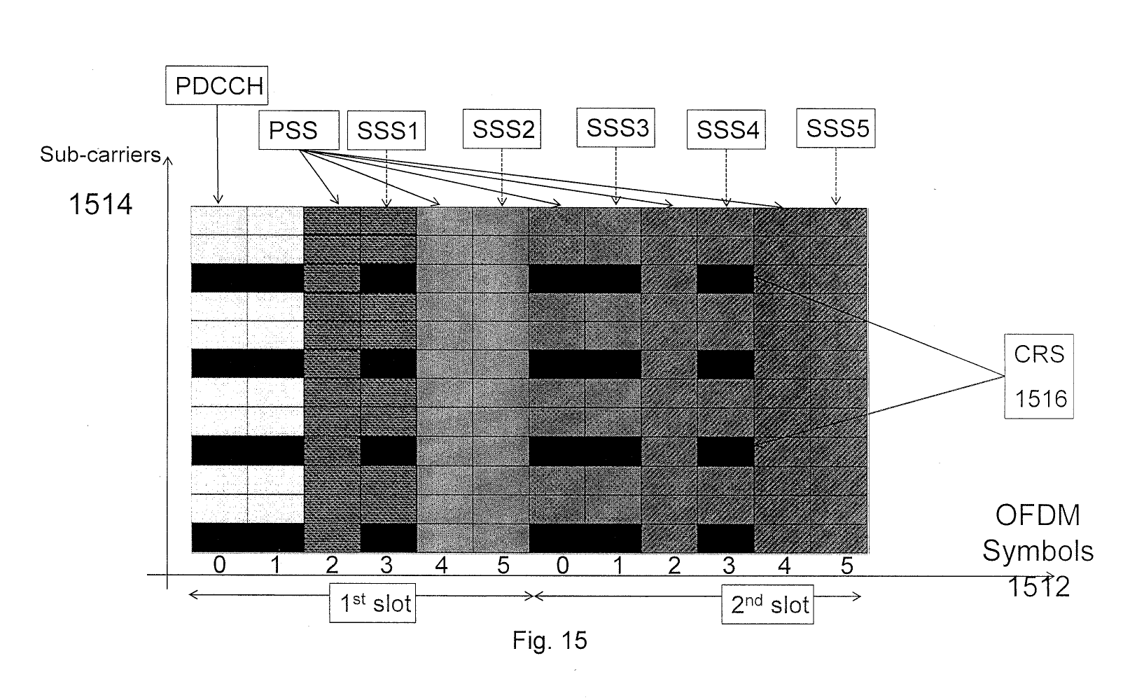

FIG. 15 illustrates an example cell search format for FDD or TDD with extended cyclic prefix. FIG. 15 illustrates two slots of an example subframe similar to FIG. 5, except each slot contains six OFDM symbols instead of seven. CRS 1516 are time-frequency resource elements used for transmission of cell-specific reference signals for a configuration with four antenna ports. Five PSS/SSS pairs are illustrated. In this example, none of the PSS are punctured by CRS 1516.

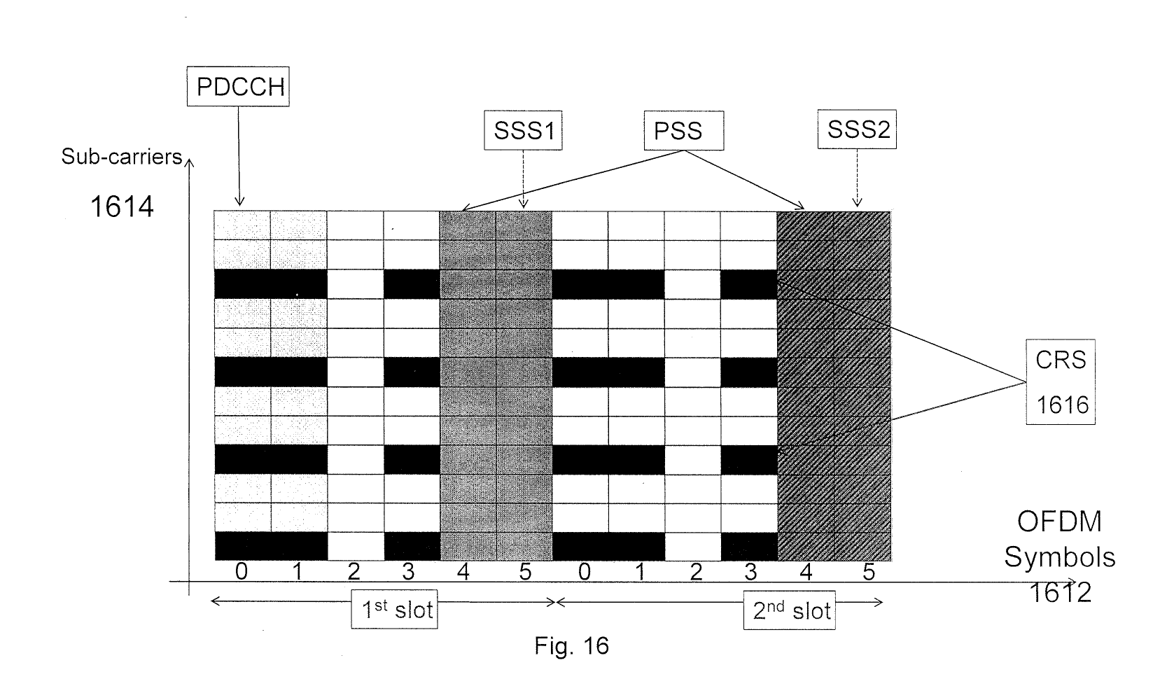

FIG. 16 illustrates an example cell search format for FDD or TDD with extended cyclic prefix. FIG. 16 illustrates two slots of an example subframe similar to FIG. 11, except each slot contains six OFDM symbols instead of seven. CRS 1616 are time-frequency resource elements used for transmission of cell-specific reference signals for a configuration with four antenna ports. Two PSS/SSS pairs are illustrated. In this example, none of the cell search signals are punctured by CRS 1616.

Although particular PSS/SSS patterns are illustrated above, additional patterns will be apparent to those skilled in the art. Furthermore, any of the patterns described above, or combination of patterns, may be repeated in other subframes within the frame.

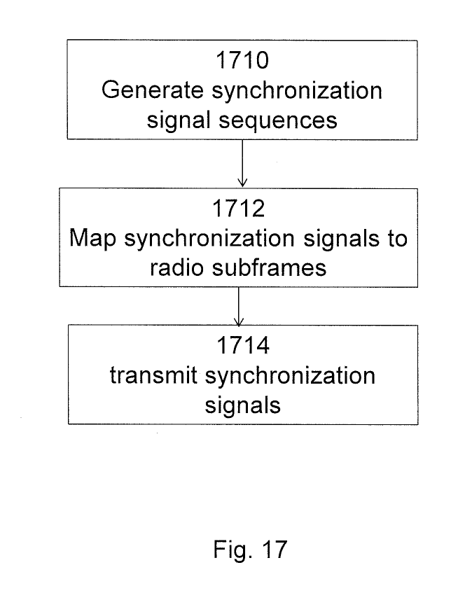

FIG. 17 is a flowchart of an example method for detecting PSS and SSS, according to a particular embodiment. In particular embodiments, one or more steps of the method may be performed by components of network 100 described with reference to FIGS. 1-16.

The method begins at step 1710, where a network node generates synchronization signals. For example, radio network node 120 may generate a plurality of PSS sequences and SSS sequences. Each PSS sequence is paired with an SSS sequence to form a PSS/SSS pair. In particular embodiments, a first PSS sequence and a second PSS sequence may comprise identical sequences. In particular embodiments, a first PSS sequence and a second PSS sequence may comprise different sequences.

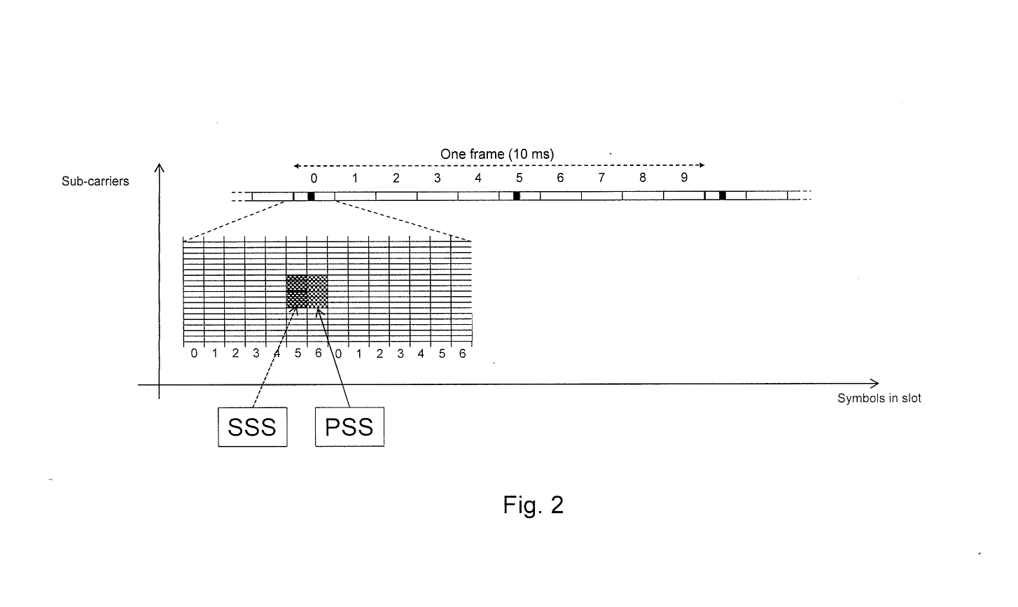

At step 1712, the network node maps the synchronization signals to radio subframes. For example, radio network node 120 may map the plurality of PSS/SSS pairs to a subframe according to any one of the frame formats described above, such as those described with respect to FIGS. 2 and 4-16. In particular embodiments, the frame format may comprise both legacy cell search signals and cell search signals according to one of the formats described above. In particular embodiments, radio network node 120 may map PSS/SSS pairs to more than one subframe or repeat a mapping or combination of mappings in multiple subframes.

At step 1714, the network node transmits the synchronization signals. For example, radio network node 120 transmits the radio frame comprising the subframes with the mapping of PSS/SSS pairs. In particular embodiments, radio network node 120 may perform directional signal transmission. For example, radio network node 120 may transmit a first PSS/SSS pair in a first direction and a second PSS/SSS pair in a second direction. In particular embodiments, radio network node 120 may transmit a first PSS/SSS pair in different directions over time.

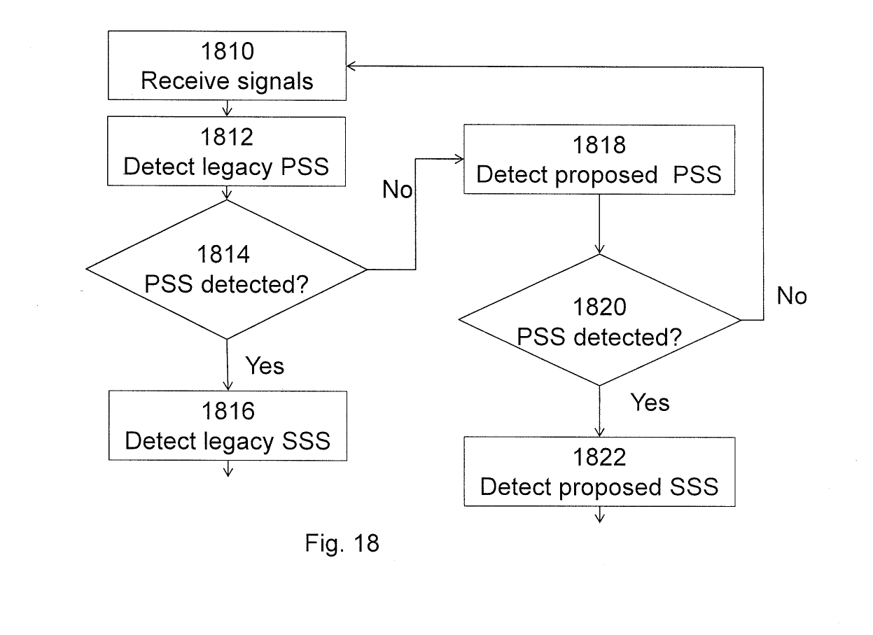

FIG. 18 is a flowchart of an example method for detecting PSS and SSS, according to a particular embodiment. In particular embodiments, one or more steps of the method may be performed by components of network 100 described with reference to FIGS. 1-17.

The method begins at step 1810, where a wireless device receives signals transmitted from a radio network node. For example, wireless device 110 may receive wireless signal 130 from radio network node 120. Wireless signal 130 may comprise primary and secondary cell search signals. For example, wireless signal 130 may comprise a plurality of PSS/SSS pairs according to any one of the frame formats described above with respect to FIGS. 2-16. In particular embodiments, wireless signal 130 may comprise both legacy cell search signals and cell search signals according to one of the formats described above, such as those described with respect to FIGS. 2 and 4-16.

At step 1812, the wireless device tries to detect a legacy PSS signal. For example, wireless device 110 may detect a legacy PSS sequence on the last OFDM symbol of slot 0. If the wireless device detects a legacy PSS at step 1814, then the method continues to step 1816 where the wireless device tries to detect a legacy SSS signal.

After detecting both primary and secondary cell search signals, the method is complete. However, if the wireless device at step 1812 is unable to detect a legacy PSS signal (e.g., because the SINR is too low), then the method continues to step 1818.

At step 1818, the wireless device tries to detect a PSS sequence, such as a PSS sequence according to one of the formats described above. In particular embodiments, wireless device 110 may accumulate multiple PSS received within a subframe or received across multiple subframes. A particular advantage is that wireless device 110 may combine signals to create a stronger signal. In particular embodiments, radio network node 120 may transmit a first PSS in a first direction and a second PSS in a second direction. A particular advantage if this transmission method is that wireless device 110 may receive a stronger PSS when radio network node 120 transmits the PSS in the direction of wireless device 110.

If the wireless device successfully detects PSS, then the method continues to step 1822. If the wireless device does not successfully detect PSS, then the method returns to step 1810 where the wireless device continues to detect signals received from the radio network node.

At step 1822, the wireless device tries to detect an SSS sequence according to one of the formats described above. Similar to detecting the PSS, the wireless device may accumulate multiple SSS and the radio network node may transmit different SSS in different directions. After detecting both primary and secondary cell search signals, the method is complete.

Modifications, additions, or omissions may be made to the method of FIG. 18. Additionally, one or more steps in the method of FIG. 18 may be performed in parallel or in any suitable order. For example, steps 1812 and 1818 may be performed in parallel or reverse order. In particular embodiments, steps 1812 to 1816 may be omitted. The method may be repeated as necessary over time, such as when a wireless device travels into a new cell coverage area.

FIG. 19 is a block diagram illustrating an example embodiment of a wireless device. The wireless device is an example of the wireless devices 110 illustrated in FIG. 1. Particular examples include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, or any other device that can provide wireless communication. The wireless device includes transceiver 1910, processor 1920, and memory 1930. In some embodiments, transceiver 1910 facilitates transmitting wireless signals to and receiving wireless signals from wireless network node 120 (e.g., via an antenna), processor 1920 executes instructions to provide some or all of the functionality described herein as provided by the wireless device, and memory 1930 stores the instructions executed by processor 1920.

Processor 1920 includes any suitable combination of hardware and software implemented in one or more integrated circuits or modules to execute instructions and manipulate data to perform some or all of the described functions of the wireless device. Memory 1930 is generally operable to store computer executable code and data. Examples of memory 1930 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

In particular embodiments, processor 1920 in communication with transceiver 1910 receives cell search signals from radio network node 120. Other embodiments of the wireless device may include additional components (beyond those shown in FIG. 19) responsible for providing certain aspects of the wireless device's functionality, including any of the functionality described above and/or any additional functionality (including any functionality necessary to support the solution described above).

FIG. 20 is a block diagram illustrating an example embodiment of a radio network node. Radio network node 120 can be an eNodeB, a node B, a base station, a wireless access point (e.g., a Wi-Fi access point), a low power node, a base transceiver station (BTS), a transmission point or node, a remote RF unit (RRU), a remote radio head (RRH), or other radio access node. Radio network node 120 includes at least one transceiver 2010, at least one processor 2020, at least one memory 2030, and at least one network interface 2040. Transceiver 2010 facilitates transmitting wireless signals to and receiving wireless signals from a wireless device, such as wireless devices 110 (e.g., via an antenna); processor 2020 executes instructions to provide some or all of the functionality described above as being provided by a radio network node 120; memory 2030 stores the instructions executed by processor 2020; and network interface 2040 communicates signals to backend network components, such as a gateway, switch, router, Internet, Public Switched Telephone Network (PSTN), controller, and/or other radio network nodes 120. Processor 2020 and memory 2030 can be of the same types as described with respect to processor 1920 and memory 1930 of FIG. 19 above.

In some embodiments, network interface 2040 is communicatively coupled to processor 2020 and refers to any suitable device operable to receive input for radio network node 120, send output from radio network node 120, perform suitable processing of the input or output or both, communicate to other devices, or any combination of the preceding. Network interface 2040 includes appropriate hardware (e.g., port, modem, network interface card, etc.) and software, including protocol conversion and data processing capabilities, to communicate through a network.

In particular embodiments, processor 2020 in communication with transceiver 2010 transmits, to wireless device 110, cell search signals. In particular embodiments, processor 2020 in communication with transceiver 2010 transmits sell search signals such as the PSS and SSS described above to wireless device 110.

Other embodiments of radio network node 120 include additional components (beyond those shown in FIG. 20) responsible for providing certain aspects of the radio network node's functionality, including any of the functionality described above and/or any additional functionality (including any functionality necessary to support the solution described above). The various different types of radio network nodes may include components having the same physical hardware but configured (e.g., via programming) to support different radio access technologies, or may represent partly or entirely different physical components.

Some embodiments of the disclosure may provide one or more technical advantages. As an example, in some embodiments, the methods and apparatus disclosed herein may facilitate detecting synchronization signals in a low SINR environment. Cell search procedure may be performed more efficiently to improve overall system performance.

Some embodiments may benefit from some, none, or all of these advantages. Other technical advantages may be readily ascertained by one of ordinary skill in the art.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the claims below.

Abbreviations used in the preceding description include:
3GPP 3rd Generation Partnership Project
CP Cyclic Prefix
CRS Cell-Specific Reference Signal
eNB Enhanced Node-B
ePDCCH Enhance Physical Downlink Control Channel
FDD Frequency Division Duplex
LTE Long Term Evolution
OFDM Orthogonal Frequency-Division Multiplexing
PBCH Physical Broadcast Channel
PCFICH Physical Control Format Indicator Channel
PDCCH Physical Downlink Control Channel
PDSCH Physical Downlink Shared Channel
ppm Part Per Million
PSS Primary Synchronization Signal
PRACH Physical Random Access Channel
RE Resource Element
RB Resource Block
SINR Signal to Interference and Noise Ratio
SNR Signal to Noise Ratio
SSS Secondary Synchronization Signal
TDD Time Division Duplexing
UE User Equipment

1. A method of synchronizing a wireless device with a network node, the method comprising:
receiving, at the wireless device, a radio subframe transmitted from the network node, the radio subframe comprising:
a first Primary Synchronization Signal (PSS) associated with a first Orthogonal Frequency Division Multiplexing (OFDM) symbol and paired with a first Secondary Synchronization Signal (SSS) associated with a second OFDM symbol; and
a second PSS associated with a third OFDM symbol and paired with a second SSS associated with a fourth OFDM symbol;
detecting at least one of the first PSS and the second PSS within the radio subframe;
detecting at least one of the first SSS and the second SSS within the radio subframe; and
determining system information associated with the network node based on the detected at least one PSS and the detected at least one SSS.

2. The method of claim 1, wherein the first, second, third, and fourth OFDM symbols do not include OFDM symbols reserved for Physical Downlink Control Channel (PDCCH).

3. The method of claim 1, wherein the first, second, third, and fourth OFDM symbols do not include:
the last and second-to-last OFDM symbol of slot zero and the last and second-to-last OFDM symbol of slot ten within a frame configured for frequency division duplex; and
the third-position OFDM symbol of slot three and slot thirteen and the last OFDM symbol of slot two and slot twelve within a frame configured for time division duplex.

4. The method of claim 1, wherein the first, second, third, and fourth OFDM symbols do not include OFDM symbols that include Cell Reference Signals (CRS).

5. The method of claim 1, wherein a CRS time-frequency resource element punctures at least one of the first PSS, the second PSS, the first SSS, and the second SSS.

6. The method of claim 1, wherein the first PSS and the second PSS comprise different sequences.

7. The method of claim 1, wherein the first PSS and the first SSS are associated with adjacent OFDM symbols and the first PSS is transmitted before the first SSS.

8. The method of claim 1, wherein the first PSS and the first SSS are associated with adjacent OFDM symbols and the first SSS is transmitted before the first PSS.

9. The method of claim 1, wherein the first PSS and the first SSS are associated with OFDM symbols that are separated by two OFDM symbols.

10. The method of claim 1, further comprising:
detecting both the first PSS and the second PSS within the radio subframe;
accumulating the first PSS and the second PSS; and
determining system information associated with the network node based on the accumulated first PSS and second PSS.

11. The method of claim 1, further comprising:
detecting both the first SSS and the second SSS within the radio subframe;
accumulating the first SSS and the second SSS; and
determining system information associated with the network node based on the accumulated first SSS and second SSS.

12. The method of claim 1, further comprising:
accumulating the detected at least one PSS and a PSS detected in a previously received subframe; and
determining system information associated with the network node based on the detected at least one PSS and the PSS detected in a previously received subframe.

13. The method of claim 1, further comprising:
accumulating the detected at least one SSS and a SSS detected in a previously received subframe; and
determining system information associated with the network node based on the detected at least one SSS and the SSS detected in a previously received subframe.

14. A method of transmitting synchronization signals in a wireless network, the method comprising:
generating a first Primary Synchronization Signal (PSS) comprising a first synchronization sequence and a second PSS comprising a second synchronization sequence;
generating a first Secondary Synchronization Signal (SSS) comprising a third synchronization sequence and a second SSS comprising a fourth synchronization sequence;
mapping the first PSS, first SSS, second PSS, and second SSS to a radio subframe, wherein:
the first PSS is associated with a first Orthogonal Frequency Division Multiplexing (OFDM) symbol and paired with the first SSS associated with a second OFDM symbol;
the second PSS is associated with a third OFDM symbol and paired with the second SSS associated with a fourth OFDM symbol; and
transmitting the radio subframe.

15. The method of claim 14, wherein the first, second, third, and fourth OFDM symbols do not include OFDM symbols reserved for Physical Downlink Control Channel (PDCCH).

16. The method of claim 14, wherein the first, second, third, and fourth OFDM symbols do not include:
the last and second-to-last OFDM symbol of slot zero and the last and second-to-last OFDM symbol of slot ten within a frame configured for frequency division duplex; and
the third-position OFDM symbol of slot three and slot thirteen and the last OFDM symbol of slot two and slot twelve within a frame configured for time division duplex.

17. The method of claim 14, further comprising transmitting the first PSS in a first direction and the second PSS in a second direction.

18. The method of claim 14, further comprising transmitting the first SSS in a first direction and the second SSS in a second direction.

19. A wireless device comprising a processor operable to:
receive a radio subframe transmitted from a network node, the radio subframe comprising:
a first Primary Synchronization Signal (PSS) associated with a first Orthogonal Frequency Division Multiplexing (OFDM) symbol and paired with a first Secondary Synchronization Signal (SSS) associated with a second OFDM symbol; and
a second PSS associated with a third OFDM symbol and paired with a second SSS associated with a fourth OFDM symbol;
detect at least one of the first PSS and the second PSS within the radio subframe;
detect at least one of the first SSS and the second SSS within the radio subframe; and
determine system information associated with the network node based on the detected at least one PSS and the detected at least one SSS.

20. The wireless device of claim 19, wherein the first, second, third, and fourth OFDM symbols do not include OFDM symbols reserved for Physical Downlink Control Channel (PDCCH).

21. The wireless device of claim 19, wherein the first, second, third, and fourth OFDM symbols do not include:
the last and second-to-last OFDM symbol of slot zero and the last and second-to-last OFDM symbol of slot ten within a frame configured for frequency division duplex; and
the third-position OFDM symbol of slot three and slot thirteen and the last OFDM symbol of slot two and slot twelve within a frame configured for time division duplex.

22. The wireless device of claim 19, wherein the first, second, third, and fourth OFDM symbols do not include OFDM symbols that include Cell Reference Signals (CRS).

23. The wireless device of claim 19, wherein a CRS time-frequency resource element punctures at least one of the first PSS, the second PSS, the first SSS, and the second SSS.

24. The wireless device of claim 19, wherein the first PSS and the second PSS comprise different sequences.

25. The wireless device of claim 19, wherein the first PSS and the first SSS are associated with adjacent OFDM symbols and the first PSS is transmitted before the first SSS.

26. The wireless device of claim 19, wherein the first PSS and the first SSS are associated with adjacent OFDM symbols and the first SSS is transmitted before the first PSS.

27. The wireless device of claim 19, wherein the first PSS and the first SSS are associated with OFDM symbols that are separated by two OFDM symbols.

28. The wireless device of claim 19, wherein the processor is further operable to:
detect both the first PSS and the second PSS within the radio subframe;
accumulate the first PSS and the second PSS; and
determine system information associated with the network node based on the accumulated first PSS and second PSS.

29. The wireless device of claim 19, wherein the processor is further operable to:
detect both the first SSS and the second SSS within the radio subframe;
accumulate the first SSS and the second SSS; and
determine system information associated with the network node based on the accumulated first SSS and second SSS.

30. The wireless device of claim 19, wherein the processor is further operable to:
accumulate the detected at least one PSS and a PSS detected in a previously received subframe; and
determine system information associated with the network node based on the detected at least one PSS and the PSS detected in a previously received subframe.

31. The wireless device of claim 19, wherein the processor is further operable to:
accumulate the detected at least one SSS and a SSS detected in a previously received subframe; and
determine system information associated with the network node based on the detected at least one SSS and the SSS detected in a previously received subframe.

32. A network node comprising a processor operable to:
generate a first Primary Synchronization Signal (PSS) comprising a first synchronization sequence and a second PSS comprising a second synchronization sequence;
generate a first Secondary Synchronization Signal (SSS) comprising a third synchronization sequence and a second SSS comprising a fourth synchronization sequence;
map the first PSS, first SSS, second PSS, and second SSS to a radio subframe, wherein:
the first PSS is associated with a first Orthogonal Frequency Division Multiplexing (OFDM) symbol and paired with the first SSS associated with a second OFDM symbol;
the second PSS is associated with a third OFDM symbol and paired with the second SSS associated with a fourth OFDM symbol; and
transmit the radio subframe.

33. The network node of claim 32, wherein the first, second, third, and fourth OFDM symbols do not include OFDM symbols reserved for Physical Downlink Control Channel (PDCCH).

34. The network node of claim 32, wherein the first, second, third, and fourth OFDM symbols do not include:
the last and second-to-last OFDM symbol of slot zero and the last and second-to-last OFDM symbol of slot ten within a frame configured for frequency division duplex; and
the third-position OFDM symbol of slot three and slot thirteen and the last OFDM symbol of slot two and slot twelve within a frame configured for time division duplex.

35. The network node of claim 32, wherein the processor is further operable to transmit the first PSS in a first direction and transmit the second PSS in a second direction.

36. The network node of claim 32, wherein the processor is further operable to transmit the first SSS in a first direction and transmit the second SSS in a second direction.
